(19) United States
(12) Patent Application Publication
(10) Pub. No.: US 2008/0162355 A1
(43) Pub. Date: Jul. 3, 2008

(54) SYSTEM AND METHOD FOR HELPING AND VERIFYING A SIGNER TO SIGN ELECTRONIC ORDERS

(75) Inventors: CHUNG-I LEE, Tu-Cheng (TW); HAI-HONG LIN, Shenzhen (CN); GUO-LING OU-YANG, Shenzhen (CN); YUE-HAI YI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/850,039

(22) Filed: Sep. 5, 2007

(30) Foreign Application Priority Data
Dec. 28, 2006 (CN) 200610201434.3

(51) Int. Cl. H04L 9/00

(52) U.S. Cl. 705/51

(57) ABSTRACT

A computer-based method for helping and verifying a signer to sign electronic orders is provides. The method includes the steps of: selecting a batch of electronic orders that need to be signed by a designated signer whose digital certificate has been recorded in advance; setting an identity for each of the selected electronic orders; signing the selected electronic orders electronically by using a digital certificate of a signer; verifying whether the signer is the designated signer of the selected electronic orders; and generating an electronic signature by using the digital certificate of the signer if the signer is verified as the designated signer, wherein the electronic signature is applied on each of the selected electronic orders according to the identities of the electronic orders. A related system is also disclosed.

### BACKGROUND OF THE INVENTION

1. Field of the Invention

The present invention generally relates to systems and methods for electronic orders, and more particularly relates to a system and method for signing electronic orders.

2. General Background

“Signature” is a very important work in an enterprise. A lot of orders need to be signed by a leader. For example, a purchase order will not to be performed if the purchase order is not authorized and signed by the leader.

Conventionally, paper orders are submitted to the leader. Due to man-made stoppage and fussy procedure, the period of signing the paper order is very long.

In October 2000, the federal Electronic Signatures in Global and National Commerce Act (also known as “E-Sign”) was enacted. The new law broadly authorizes electronic records and electronic signatures as being legally effective. Thus, electronic orders can be submitted to the leader conveniently and with fewer delay, and the leader can sign the orders electronically.

However, in the existing electronic orders signing system, a signer is only permitted to sign one electronic order at a time. If many electronic orders need to be signed, the signer must do the same work repeatedly.

### SUMMARY OF THE INVENTION

A system for helping and verifying a signer to sign electronic orders is provided. The system includes an application server. The application server includes: a selecting module configured for selecting a batch of electronic orders that need to be signed by a designated signer; an initializing module configured for setting an identity for each of the selected electronic orders; a verifying module configured for verifying whether a signer is the designated signer of the selected electronic orders when the signer signs the selected electronic orders electronically by using a digital certificate; and a signing module configured for generating an electronic signature by using the digital certificate if the signer is verified as the designated signer, wherein the electronic signature is applied on each of the selected electronic orders according to the identities of the electronic orders.

Another preferred embodiment provides a computer-based method for helping and verifying a signer to sign electronic orders. The method includes the steps of: selecting a batch of electronic orders that need to be signed by a designated signer whose digital certificate has been recorded in advance; setting an identity for each of the selected electronic orders; signing each of the selected electronic orders electronically by using a digital certificate of a signer; verifying whether the signer is the designated signer of the selected electronic orders by comparing the signer's digital certificate with the designated signer's digital certificate; and generating an electronic signature by using the digital certificate of the signer if the signer is verified as the designated signer, wherein the electronic signature is applied on each of the selected electronic orders according to the identities of the electronic orders.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of hardware configuration of a system for helping and verifying a signer to sign electronic orders in accordance with a preferred embodiment;

FIG. 2 is a schematic diagram of function modules of an application server in FIG. 1; and

FIG. 3 is a flowchart illustrating a method for helping and verifying a signer to sign electronic orders in accordance with a preferred embodiment.

### DETAILED DESCRIPTION OF THE INVENTION

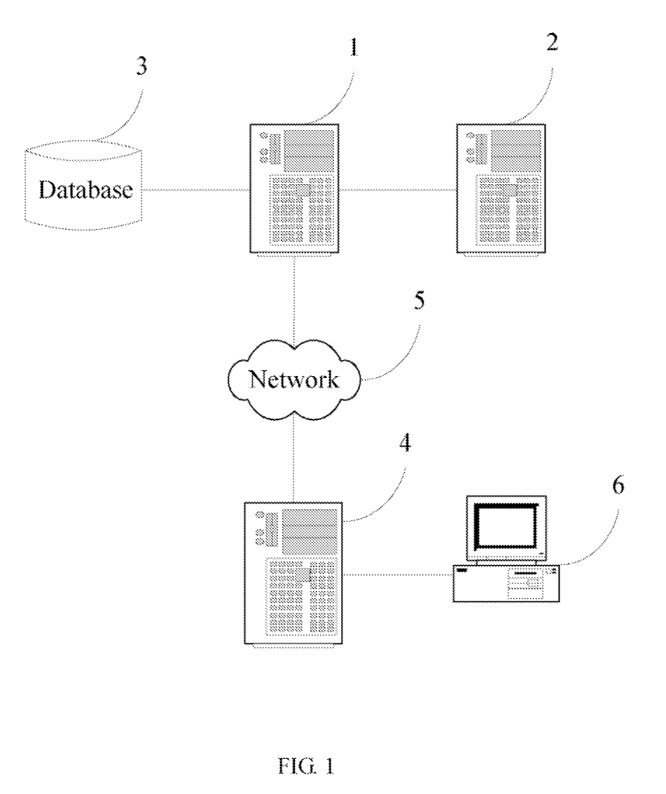

FIG. 1 is a schematic diagram of hardware configuration of a system for helping and verifying a signer to sign electronic orders (hereinafter “the system”), in accordance with a preferred embodiment. The hardware configuration of the system typically includes an application server 1, a file server 2, a database 3, a Web server 4, a network 5, and at least one client computer 6.

The application server 1 includes a plurality of software function modules, and is configured for signing a batch of electronic orders simultaneously. The file server 2 is connected with the application server 1, and is configured for storing various electronic orders. The database 3 is connected with the application server 1 via a connection (not shown). The database 3 is configured for storing digital certificates owned by different signers, and for storing data generated during signing of the electronic orders. The Web server 4 is connected with the application server 1 via the network 5. The signers can login into the application server 1 via the Web server 4. The network 5 may be the Internet, an intranet, or any other networks. The client computer 6 is connected with the Web server 4, and is configured for providing a user interface for the signers.

In an alternative embodiment, the application server 1, the file server 2, and the Web server 4 can also be replaced by one server that has the functions of the server 1, the file server 2, and the Web server 4.

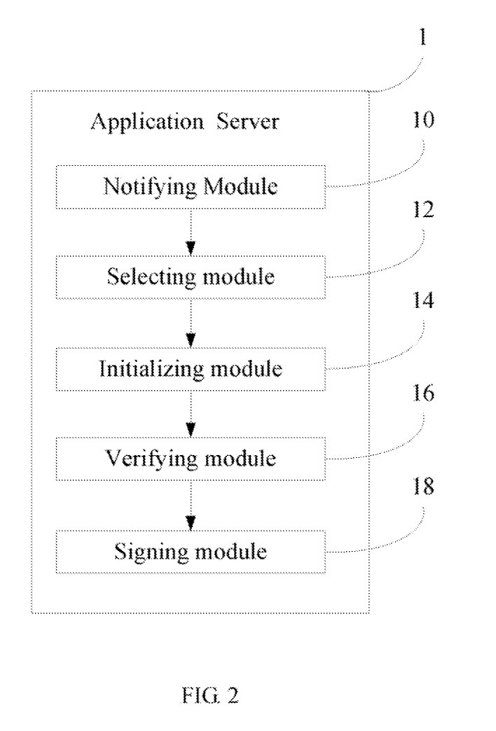

FIG. 2 is a schematic diagram of function modules of the application server 1 in FIG. 1. The application server 1 mainly includes: a notifying module 10, a selecting module 12, an initializing module 14, a verifying module 16, and a signing module 18

The notifying module 10 is configured for notifying a corresponding signer to sign electronic orders electronically when a batch of electronic orders that need to be signed exists in the file server 2.

The selecting module 12 is configured for selecting the batch of electronic orders that need to be signed by a designated signer, thereby yielding selected electronic orders.

The initializing module 14 is configured for setting an identity for each of the selected electronic orders. The identities are used for identifying the electronic orders that need to be signed simultaneously. The identities for each of the selected electronic orders can be stored in the database 3.

The verifying module 16 is configured for verifying whether the signer is the designated signer of the selected electronic orders when the signer signs the selected electronic orders by using his/her digital certificate. The verification of the signer is performed by comparing the digital certificate of the signer with a digital certificate of the designated signer of the selected electronic orders. If the digital certificate of the signer is verified to be identical to the digital certificate of the designated signer, the signer is qualified; otherwise, the signer is unqualified.

The signing module 18 is configured for generating an electronic signature by using the digital certificate of the signer if the signer is verified as the designated signer, wherein the electronic signature is applied on each of the selected electronic orders according to the identities of the selected electronic orders.

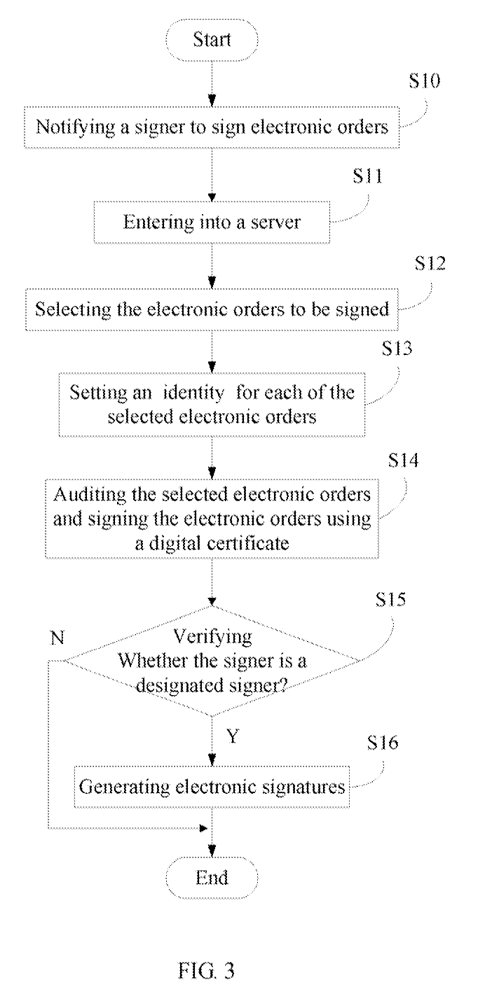

FIG. 3 is a flowchart illustrating a method for helping and verifying a signer to sign electronic orders in accordance with a preferred embodiment.

In step S10, when a batch of electronic orders that need to be signed exists in the file server 2, the notifying module 10 notifies a corresponding signer to sign the electronic orders electronically.

In step S11, after receiving the notification, the signer may login into the application server 1 via the Web server 4.

In step 12, the selecting module 12 selects the batch of electronic orders that need to be signed by a designated signer whose digital certificate has been recorded in advance.

In step S13, the initializing module 14 sets an identity for each of the selected electronic orders. The identities are used for identifying the electronic orders that need to be signed simultaneously.

In step S14, the signer audits the selected electronic orders, and signs the electronic orders electronically by using his/her digital certificate.

In step S15, the verifying module 16 verifies whether the signer is the designated signer of the selected electronic orders by comparing the digital certificate of the signer with the digital certificate of the designated signer.

If the digital certificate of the signer is different from the digital certificate of the designated signer, the signer is unqualified, and the procedure ends. Otherwise, if the digital certificates of the signer and the designated signer are identical, the signer is qualified. In step S16, the signing module 18 generates an electronic signature by using the digital certificate of the signer if the signer is verified as the designated signer, wherein the electronic signature is applied on each of the selected electronic orders according to the identities of the electronic orders.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for helping and verifying a signer to sign electronic orders comprising an application server, the application server comprising:
a selecting module configured for selecting a batch of electronic orders that need to be signed by a designated signer;
an initializing module configured for setting an identity for each of the selected electronic orders;
a verifying module configured for verifying whether a signer is the designated signer of the selected electronic orders when the signer signs the selected electronic orders electronically by using his/her digital certificate; and
a signing module configured for generating an electronic signature by using the digital certificate of the signer if the signer is verified as the designated signer, wherein the electronic signature is applied on each of the selected electronic orders according to the identities of the electronic orders.

2. The system according to claim 1, wherein the application server further comprises:
a notifying module configured for notifying the signer to sign the batch of electronic orders electronically.

3. The system according to claim 1, wherein the verifying module verifies whether the signer is the designated signer of the selected electronic orders by comparing the digital certificate of the signer with a digital certificate of the designated signer.

4. A computer-based method for helping and verifying a signer to sign electronic orders, the method comprising:
selecting a batch of electronic orders that need to be signed by a designated signer whose digital certificate has been recorded in advance;
setting an identity for each of the selected electronic orders;
signing the selected electronic orders electronically by using a digital certificate of a signer;
verifying whether the signer is the designated signer of the selected electronic orders; and
generating an electronic signature by using the digital certificate of the signer if the signer is verified as the designated signer, wherein the electronic signature is applied on each of the selected electronic orders according to the identities of the electronic orders.

5. The method according to claim 4, further comprising:
notifying the signer to sign the batch of electronic orders electronically.

6. The method according to claim 4, wherein the verifying step is performed through comparing the digital certificate of the signer with the digital certificate of the designated signer.
